(19) United States
(12) Patent Application Publication
(10) Pub. No.: US 2002/0118364 A1
(43) Pub. Date: Aug. 29, 2002

(54) Detection of trace levels of water

(76) Inventors: James E. Amonette, Richland, WA (US); S. Thomas Autrey, West Richland, WA (US); Nancy S. Foster-Mills, Richland, WA (US); Bary W. Wilson, Richland, WA (US)

Correspondence Address: Stephen R. May, Intellectual Property Services, Battelle Memorial Institute, P.O. Box 999, Richland, WA, 99352, US

(21) Appl. No.: 09/745,029

(22) Filed: Dec. 20, 2000

(51) Int. Cl. G01N 21/00

(52) U.S. Cl. 356/436

(57) ABSTRACT

Methods and apparatuses for detecting low levels of a substance of interest in a sample using photoacoustic spectroscopy are provided. This method comprises exciting the sample with light having a wavelength that is absorbed by the substance of interest; generating an acoustic wave within the sample; detecting the acoustic wave; and determining the amount of the substance of interest present in the sample. The method can be used to detect the amount of water in an oil sample at detection limits lower than currently available.

### STATEMENT REGARDING FEDERALLY SPONSORED RESEARCH OR DEVELOPMENT

This invention was made with Government support under Contract DEAC0676RL01830 awarded by the U.S. Department of Energy. The Government has certain rights in the invention.

### BACKGROUND OF THE INVENTION

Most machinery requires lubrication by oil to operate efficiently and reliably. Oil is also used as a hydraulic fluid in heavy equipment. Both lubrication and hydraulic oils can degrade by contamination from dirt, soot, process or wear materials, process chemicals, fuel dilution, or water. Water is the most common contaminant usually as a consequence of condensation, coolant leak or free water ingress during equipment cleaning or environmental exposure. Water at concentrations greater than about 1000 ppm can result in destructive wear and corrosion of parts as well as oxidation or degradation of the oil (Toms, L. A., Machinery Oil Analysis: Methods, Automation & Benefits 2nd ed. 1998, p. 141, Virginia Beach: Coastal Skills Training). Knowledge of the condition of oil in equipment is necessary in order to change the oil in a cost-effective manner. Premature oil change results in unnecessary cost as well as a waste in oil reserves. Changing the oil too late can result in part wear and possible equipment failure.

For early-warning and maintenance-scheduling purposes, detection limits of 10-50 ppm water in oil are desirable. Detection limits as low as 10 ppm are possible using Karl-Fischer titration. However, this technique is unsuitable for accurate, real-time, in-situ determinations of water levels in used oil because it requires a substantial sample size, is sample destructive and time consuming, and is subject to severe interferences from sulfur compounds present in most engine oils (ASTM D6304-00). Accurate, real-time, in-situ determinations of water can be made using Fourier-transform infrared (FTIR) spectroscopy, but the best currently achievable detection limits for water in oil are on the order of 250-500 ppm (Toms, L. A., Machinery Oil Analysis: Methods, Automation & Benefits 2nd ed. 1998, p. 141-144 Virginia Beach: Coastal Skills Training).

Photoacoustic spectroscopy (“PAS”) has detection limits that are typically 10-1000 times lower than other purely absorption-based spectroscopies. A photoacoustic signal can be generated as follows. First, light stimulates a molecule within a sample. Such stimulation can include, for example, absorption of the light by the molecule to change an energy state of the molecule. Second, an excited-state structure of the stimulated molecule rearranges. During such rearrangement, heat, light, volume changes and other forms of energy can dissipate into an environment surrounding the molecule. Such forms of energy cause expansion or contraction of materials within the environment. As the materials expand, sound waves are generated. Accordingly, an acoustic detector mounted in acoustic communication with the environment can detect changes occurring as a result of the light stimulation of the absorbing molecule.

A method of estimating the volume fraction of water in kerosene or toluene using a 10.2 cm diameter, 10-100 cm long cell by measuring the travel time of a ultrasonic wave through a temperature-controlled mixture and using a mathematical model has been reported (Tsouris, C., Tavlarides, L. Volume Fraction Measurements of Water in Oil by an Ultrasonic Technique. Ind. Eng. Chem. Res., 1993. 32: p. 998-1002). Also, Hodgson reported a PAS sensor to detect oil in water (Hodgson, P., et al., Application of Pulsed Laser Photoacoustic Sensors in Monitoring Oil Contamination in Water. Sensors and Actuators B, 1995. 29: p. 339-344). These techniques do not have sufficient sensitivity to detect low levels of water in oil.

Sensors based on PAS have recently been designed to monitor various other species including serum glucose levels (MacKenzie, H. A., et al., Advances in Photoacoustic Noninvasive Glucose Testing. Clinical Chemistry, 1999. 45: p. 1587-1595), hydrogen concentration ratios and CO₂ (Schlageter, B., et al., Development of an Optoacoustic Sensor Module for pH and/or CO₂ Determination in Aqueous Solutions. Sens. Actuators, B, 1997. B39(1-3): p. 443-447), oil in water, hydrogen gas (Wan, J. K. S., M. S. loffe, and M. C. Depew, A Novel Acoustic Sensing System for On-Line Hydrogen Measurements. Sensors and Actuators B, 1996. 32: p. 233-237), and biomass fermentation (Schmidt, K. and D. Beckmann, Biomass Monitoring using the Photoacoustic Effect. Sensors and Actuators B, 1998. 51: p. 261-267). Lai and Vucic used PAS to monitor the degradation of motor oil by exciting the aromatic hydrocarbons at 355 nm (Lai, E. P. C. and R. S. Vucic, Kinetic Study of the Degradation ofLubricating Motor Oil by Liquid Chromatography and Photoacoustic Spectrometry. Fresenius J. Anal. Chem., 1993. 347: p. 417-422). A method of detecting 3% water in ethanol by exciting a water/ethanol solution with 2 GHz microwave radiation and detecting the emitted acoustic signal with a PVDF microphone has been reported (Raikkonen, Oksanen, Microwave Acoustic Sensing of Water in Hydrocarbon/Water Solutions. Sensors and Actuators, 1994. A 45: p. 99-101). U.S. Pat. No. 5,348,002 (Caro) issued Sep. 20, 1994 disclosed a method of determining the amount of glucose or oxygen in biological fluids which have a high degree of scatter by generating an acoustic signal in the material, detecting the absorption coefficient of the material and using mathematical analysis techniques.

The methods reported do not have sufficient sensitivity to detect low levels of water in oil and other absorbing substances in a nonwater sample. Therefore, there is a need for a technique to detect low levels of an absorbing substance in a nonwater system, such as water in oil. There is also a need for a rugged and sensitive technique that can be used in situ (in an on-line application).

### SUMMARY OF THE INVENTION

Provided is a method of determining the concentration of a substance of interest in a nonwater sample comprising: exciting the sample with a wavelength of light that is absorbed by the substance of interest; generating an acoustic wave within the sample; detecting the acoustic wave; and determining the amount of the substance of interest present in the sample. The substance of interest is preferably water. The sample is preferably oil. The substance of interest may be present in the sample at various concentrations, as described herein.

Also provided is a preferred method of determining the concentration of water in an oil sample which contains less than 1% water comprising: exciting the sample with light having a wavelength water absorbs; generating an acoustic wave within the sample; detecting the acoustic wave with a transducer in acoustic communication with the sample; and determining the amount of water present in the sample by processing the signal detected by the transducer. In this preferred embodiment, it is preferred that the light has a wavelength less than 1 mm.

Also provided is an apparatus for detecting the concentration of a substance of interest in a nonwater sample comprising an excitation source which provides light having a wavelength that is absorbed by the substance of interest; a sample in light contact with the source; and a detector in acoustic communication with the sample. Preferably, the apparatus is used to detect the concentration of water in oil. The apparatus is also useful to detect the presence of water in nonwater chemicals, among other substances.

A preferred use of the apparatus is to determine the concentration of water in an oil sample where the apparatus comprises: an excitation source which provides pulsed or modulated light having a wavelength water absorbs; a prism cell in light contact with the excitation source; and a transducer in acoustic communication with the sample.

### BRIEF DESCRIPTION OF THE DRAWINGS

FIG. 1. PAS calibration curves for clean hydraulic (+), transmission (•), and engine (x) oils with water. The error bars represent ±3 standard deviations.

FIG. 2. PAS signal for transmission oil with standard additions of water. The error bars represent ±3 standard deviations.

FIG. 3. PAS response for NIST SRM 8705 and this oil ‘dried’ with molecular sieve for 48 hours. The error bars represent ±1 standard deviation.

### DETAILED DESCRIPTION OF THE INVENTION

Although the description herein is directed to preferred embodiments, it should be understood that the invention is not limited to the specific embodiments described. The methods described herein provide nondestructive sampling, high sensitivity, and nearly instantaneous data collection capabilities. No moving parts are required, and rugged solid-state light sources, sampling cells and detectors can be used. The methods and apparatuses described herein are selective for species of interest. The methods and apparatuses described herein can be used in a stand-alone application, either as a bench-top apparatus or a portable apparatus, can be used in an in-line flow stream application, or used for remote sensing applications.

Samples which may be analyzed include oil, hydrocarbon-based fuels, packaged foods, chemicals, and other samples which contain an absorbing substance that is desired to be either detected or quantitated, and where the absorbance spectra of the substance of interest and the sample are different. In a preferred embodiment, the sample is oil. One class of samples is biological fluids.

The substance of interest which is detected or quantitated may be any absorbing substance. An “absorbing substance” is one which absorbs at least some of the light which is applied. Absorbance indicates the absorbing substance has an absorbance that is detectable above the background absorbance of the sample. Absorbing substances include water (light water, heavy water), trace chemicals, compounds comprising OH groups (e.g., alcohols), solvents, and additives such as those present in oil and hydrocarbon-based fuels. The sample may contain immiscible substances, such as a large amount of water in an oil sample.

Nonwater samples are those containing less than 100% water. Particular classes of samples include those with less than 80% water, less than 60% water, less than 50% water, less than 40% water, less than 20% water, less than 10% water, less than 1% water, less than 1000 ppm water, less than 250 ppm water, less than 50 ppm water and all intermediate ranges therein. Nonwater samples include oil.

Determining the amount of the substance of interest in the sample may be performed by any method known in the art, those methods described herein, and by modifications of the methods known in the art and described herein that may be performed by one of ordinary skill in the art without undue experimentation. One such method is the method of standard additions. The presence of the substance of interest in the sample may also be detected using the methods and apparatuses described herein.

The excitation source may be any source that generates a wavelength of light that is absorbed by the substance of interest. The light may have any wavelength or combination of wavelengths that is sufficient to cause a detectable signal. The light is preferably pulsed or modulated. The light may come from a pulsed source, or a chopper may be used to modulate light which is continuous. In addition, one pulse of light from a source may be used to generate a signal.

Various light sources are useful in the methods described herein. These include, but are not limited to lasers (including solid-state Er-YAG, quantum-cascade solid-state lasers, Pb-salt diode lasers, and other infrared diode lasers) and flashlamps, including Xe flashlamps used in trigger sockets, for example (wavelengths can be selected with notch filters, among other methods known in the art). The selection of the light source used is made by considering the absorbance spectrum of the substance of interest and the particular transitions desired to be excited, as is well known in the art. It is preferred that the light be provided by a source of electromagnetic radiation having a wavelength including but not limited to x-ray, ultraviolet, visible, near infrared, infrared, and combinations thereof. One class of wavelengths is the microwave range. Another class of wavelengths has wavelengths shorter than microwave. For example, to detect water, light in the IR range (770 nm-50 μm), is useful because water absorbs light of that range. A broadband source may be used with appropriate filtering devices to select the wavelength of interest. A multiwavelength source may be used with dielectric mirrors or filters to detect more than one wavelength simultaneously. Any light source may be used that is absorbed by the substance of interest and provides sufficient energy to generate an acoustic wave that is detectable above background. The detectability of an acoustic wave is affected by the detector characteristics and data collection apparatus used, as is known in the art. Laser diodes provide sufficient monochromatic light to generate a detectable acoustic wave and are particularly useful in miniaturized versions of the methods and apparatuses described herein. Use of a Xe flash lamp and notch filter can also provide appropriate light at a significantly lower cost.

One embodiment of the invention provides pulsed or modulated monochromatic light to a sample at a wavelength where water absorbs strongly and other components of the sample do not. In petroleum-based oils, hydrocarbon-based fuels (e.g. gasoline, diesel, kerosene), and most organic solvents, one such wavelength is about 2.94 μm where pure water has its highest absorptivity (1.2 ×10⁴ cm⁻¹) due to O-H stretching vibrations. For synthetic oils having polyolester or phosphate ester base stocks, this wavelength is somewhat shorter (about 2.75 μm). Other wavelengths are useful, depending on the sample matrix. These wavelengths are easily determined by one of ordinary skill in the art without undue experimentation using the methods described herein and methods known in the art. Another embodiment of the invention uses light which is not monochromatic. Wavelength selection may be made with appropriate filters, for example.

Various sampling devices can be used in the method described herein. It is preferred that there is a transparent surface such as a window or prism to transmit light into the sample, but it is not required. The invention does not require sample cells that are on the order of 10 cm diameter and 10- 100 cm long. One preferred sample device is a layered prism cell, as described in U.S. patent application Ser. No. 09/105,78 1, filed June 1998, and Autrey, T., et al., A New Angle into Time-Resolved Photoacoustic Spectroscopy: A Layered Prism Cell Increases Experimental Flexibility. Rev. Sci. Instrum., 1998, 69(6): p. 2246-2258, both of which are hereby incorporated herein by reference to the extent not inconsistent with the disclosure herein. The layered prism cell includes a first block of material with opposing front and back surfaces. The front surface comprises a substantially planar portion configured to be against a sample. The back surface comprises a substantially planar portion configured to be joined to a transducer. The back surface is substantially parallel to the front surface. The first block of material also has a pair of opposing side surfaces joined to opposite ends of the front and back surfaces. The opposing side surfaces are a first opposing side surface and a second opposing side surface. The first opposing side surface is configured for passage of light therethrough and extends at a first oblique angle relative to a plane containing the substantially planar portion of the front surface. The second opposing side surface extends at a second oblique angle relative to the plane containing the substantially planar portion of the front surface. There may also be a second block separated from the first block by a shim. The second block may be from the same material or a different material than the first block. The sample cell also has embodiments in which a sample reservoir or similar structure is against a surface of a block, regardless of whether a second block is provided.

Both transmission and internal-reflectance geometries can be used in flow-through cell configurations, as well as static sampling. These cells and methods of using the cells are known in the art. It is recognized that light can be either refracted or reflected by a material, depending on an angle with which the light impacts a surface of the material. A critical angle is determined by the relative refractive indices of materials joining at a surface. Specifically, if light passes from a first material having a larger refractive index to a second material with a lesser refractive index, a critical angle can be defined relative to an axis normal to a surface where the two materials meet. If light impacts the surface where the two materials meet at an angle greater than the critical angle, the light will predominantly reflect from this surface. If light impacts the surface where the two materials meet at an angle less than the critical angle, the light will predominantly pass into the cell material and refract within the cell material. A critical angle can be calculated from application of Snell's law, as known in the art, and the relative amount of refraction and reflection can be determined.

Incident light may be directed into the cell at an appropriate angle such that the light reflects from surfaces of the material to be contained internally in the cell material. Such reflections are referred to as internal reflections. It is known that some of the light will actually extend slightly outward of a surface of the material as the light reflects internally from the surface. Although the light extends slightly outward of the surfaces of the material as it is reflected within the material, the light continues along the general path illustrated by the light beam. Accordingly, if cell material is provided adjacent to a sample, a light beam can be provided to be internally reflective within the cell material and yet to stimulate molecules within the sample. Such use of internal reflections for stimulating molecules within a sample can be advantageous in situations where a sample is generally not transparent to a light source, such as, for example, when the sample is relatively turbid or optically dense. The amount by which the light waves penetrate into a sample can be adjusted by changing a wavelength of the light, or by changing an angle at which the light internally reflects from surfaces of the cell material.

Various detection and data processing methods may be used in the methods of the invention as are known in the art. For example, a digital oscilloscope can be used to digitize the signal from the detector. Digitizing electronics can be triggered by the incident light pulse, or other embodiments known to the art. Data acquisition cards can also be used. Detectors are preferably acoustic microphones or transducers that are in acoustic communication with the sample. A detector in acoustic communication with the sample, as used herein, is defined as a detector that is acoustically coupled with the sample so that the detector receives useful information from the sample by acoustic transmission. Such coupling may be accomplished by having the detector in direct contact with the sample or by using a gas, liquid, solid, or combinations thereof therebetween to acoustically couple the detector with the sample. One embodiment of the invention uses one or more than one detector in acoustic communication with the sample. Transducers with different resonant frequencies can be used to improve selectively, as described in U.S. patent application Ser. No. 09/322,910, filed Jun. 1, 1999, incorporated by reference herein to the extent not inconsistent with the disclosure herewith. Photoacoustic selectivity using different resonant frequencies is achieved by analyzing the response of the various frequency transducers to the time-dependent release of heat from the electronic and/or vibrational excited state species. For example, the response of a 1 MHz transducer and a 5 MHz transducer will have a characteristic shape defined by the concentration and excited state lifetime of the species absorbing the energy. The time-dependent response provided by an ultrasonic transducer from the competitive absorption of light by multiple species may be mathematically described and analyzed for the unique solution that provides the concentration of each of the species, as described in further detail in U.S. patent application No. 09/322,910.

An electrical interconnect may extend from the detector to electrically couple the detector with circuitry for either processing or displaying signals generated by the detector.

Optics for directing the light into the sample cell are known in the art and may include wedges, filters, beam splitters, irises, fiber optics, lenses, as well as other optical devices.

“Oil” is a naturally-ocurring or synthetic substance or mixture of substances that contains hydrocarbons, and may optionally contain other substances such as additives (including antioxidants, detergent-dispersants, wear preventives, rust preventives, sequestering agents, friction-coefficient modifiers, defoaming agents, colorants, seal-swelling agents and viscosity-index improvers) and heteroatom-containing substances such as alcohols and other oxygen-, sulfur- or nitrogen-containing compounds. “Oil” includes all petroleum-based, natural, and synthetic oils, including all types of engine oils, such as transmission and hydraulic, all edible oils, including olive oil, vegetable oil and canola oil, and other oils.

The methods described herein can be used for on-line analysis of lubricating oils in large or critical-mission machinery such as stationary diesel and gas-turbine engines for power generation and marine propulsion, locomotive engines, heavy equipment, military weapons platforms, trucks and automobiles. Also, hydraulic fluids in heavy equipment and aircraft can be analyzed. The methods described herein can also be used for process monitoring in food production and organic chemical production/use (for example, production of polymers), as well as humidity sensors. Other applications will be apparent to one of ordinary skill in the art. Using the methods and devices described herein, trace levels of water in nonwater samples, including petroleum and synthetic lubrication oils can be detected. Trace levels of water in petroleum oils using PAS can be performed at detection levels at least 5 -1 0 times below those obtained by conventional absorption-spectroscopic techniques. Samples with water concentrations of less than about 1000 ppm, less than about 750 ppm, less than about 500 ppm, less than about 250 ppm, less than about 100 ppm, less than about 50 ppm, and lower, and all intermediate ranges therein can be detected in an oil sample using the methods and apparatuses described herein. Detection limits of 50 ppm are easily obtainable, and limits of 10-20 ppm are achievable with optimization of the methods and apparatuses described herein. Detection limits from ultratrace up to nearly 100% of the substance of interest in a nonwater sample are provided, along with all intermediate ranges therein.

An appropriate wavelength for use in sample excitation can be selected by methods known in the art, or methods described herein. One method of selecting an appropriate wavelength for excitation is described here. The absorbance spectrum of water or the substance of interest is measured along with the absorbance spectrum of the major components of the sample. Those spectra are compared, and a wavelength where the substance of interest absorbs more strongly than the components of the sample is selected. As long as the substance of interest absorbs the wavelength selected, the measurements may be performed using appropriate mathematical manipulation of the data, as known in the art.

The techniques described herein are useful in determining the concentration or presence of water in oil in a static sample or may be used in a flowing stream. One embodiment of using the invention in a flowing-stream environment comprises positioning a light source and a detector on opposite sides of a sample contained in, for example, a tube such as a pipe. In this embodiment, the light source will excite the substance of interest. The acoustic wave generated will travel to the detector. The contribution of the distance between the light source and the detector to the signal can be taken into account by mathematical relationships known to those in the art or readily determinable without undue experimentation. Another embodiment has the detector on any side of the light source. The detector may also be some distance from the light source and on the same side, provided that acoustic coupling between the sample and detector is maintained. Other geometries and arrangements between components of the apparatus are useful, as known in the art.

### EXAMPLES

Unused transmission, hydraulic, and engine-oil samples from the U.S. Army tank maintenance facility at the Yakima Firing Range, WA were studied. The transmission and hydraulic oils were petroleum oils. The transmission fluid was a Dextron-type petroleum-based fluid. The hydraulic fluid also was largely petroleum-based and conformed to MIL H 83232. The engine oil was a synthetic polyolester based oil for use in gas turbine engines (MIL L 23699) and contained few, if any, additives. The transmission and engine oils are the types currently used to lubricate M1 Abrams tanks. A reference mineral oil from the National Institute of Standards and Technology (SRM 8507) certified to have 76.8 (±2.3) ppm water was also tested. The method of standard additions was used to prepare samples of clean oil with known relative water contents. Briefly, 10-20 mL of oil was placed in a tared 22-mL glass vial with a stir bar. While on the balance, aliquots of water (ca. 5-10 μL) were added. The actual amounts added were determined by weight. After capping the vials, the oil/water mixtures were then stirred for 15-30 minutes or until complete miscibility was obtained as determined by visual inspection. Samples of the clean oils and the reference material were also treated for at least 15 hours with a molecular sieve (5 g 4 Åpore size 4-8 mesh beads, which had been heated 1 week at 120° C. in 10 mL oil) to remove water that might have already been present in the oils.

Data was collected using the flow-through layered prism cell (described in Autrey, T., et al., A New Angle into Time-Resolved Photoacoustic Spectroscopy: A Layered Prism Cell Increases Experimental Flexibility. Rev. Sci. Instrum., 1998, 69(6): p. 2246-2258) with a sapphire entrance prism, quartz exit prism, and an optical pathlength of 0.76 mm. Acoustic communication with the transducer (0.25-inch diameter, 5-MHz Panametrics) was facilitated by an ultrasonic couplant fluid (Sonic Instruments). Excitation light of 2.93 μm (3416 cm⁻¹) light was generated by Raman shifting (900 psi deuterium in a 1-m Raman cell [LightAge, #101PAL.RC-1.0]) 1.064-nm light from a pulsed Nd-YAG laser (Continuum, #NY61-20) operating at 20 Hz. Filters and mirrors were used to filter out the unwanted Raman lines. Energy per pulse was about 20 μJ. The signals from the transducer were amplified using a preamplifier (Panametrics, model 5670, 40 dB) and waveforms collected on a digital oscilloscope (Lecroy, model 9362). The water signal was monitored using a computer interface and a boxcar averager (Stanford Research Systems). Data collection software queried the boxcar averager and integrated the signal. All waveforms were signal averaged over 500 shots. The photoacoustic signal was determined by integrating the signal voltage over the time period selected by the boxcar. Data reported are the averages of twenty 500-pulse signal-averaged events (i.e., 500 s total analysis time). Detection limits were calculated (S/N=3) based on the standard deviation of the signal of the blank (n=20).

To demonstrate the selectivity of the approach, water and a series of four neat organic solvents that did or did not contain hydroxyl functional groups were tested. For the solvents that contained the hydroxyl functional groups (water, methanol and decanol), strong absorption at 2.93 μm due to O—H stretching vibrations was expected. Little absorption was expected for the other solvents that lacked the hydroxyl functional group (methylene chloride and carbon tetrachloride). The PAS results obtained for these five solvents were:

| Solvent | Peak-to-Peak signal (mV) |
|---|---|
| methylene chloride | 1.8 ± 0.5 |
| carbon tetrachloride | 5.7 ± 1 |
| water | 47 ± 1 |
| methanol | 228 ± 2 |
| decanol | 230 ± 2 |

These results show the clear selectivity of the PAS technique for substances that contain hydroxyl groups when a 2.93 μm excitation wavelength is used. The four-fold higher sensitivity to methanol and decanol than to water stems from the more favorable acoustic transmission properties of the alcohols. The very low signal levels observed for the nonhydroxylated solvents may actually reflect the presence of trace levels of water in these nominally neat solvents.

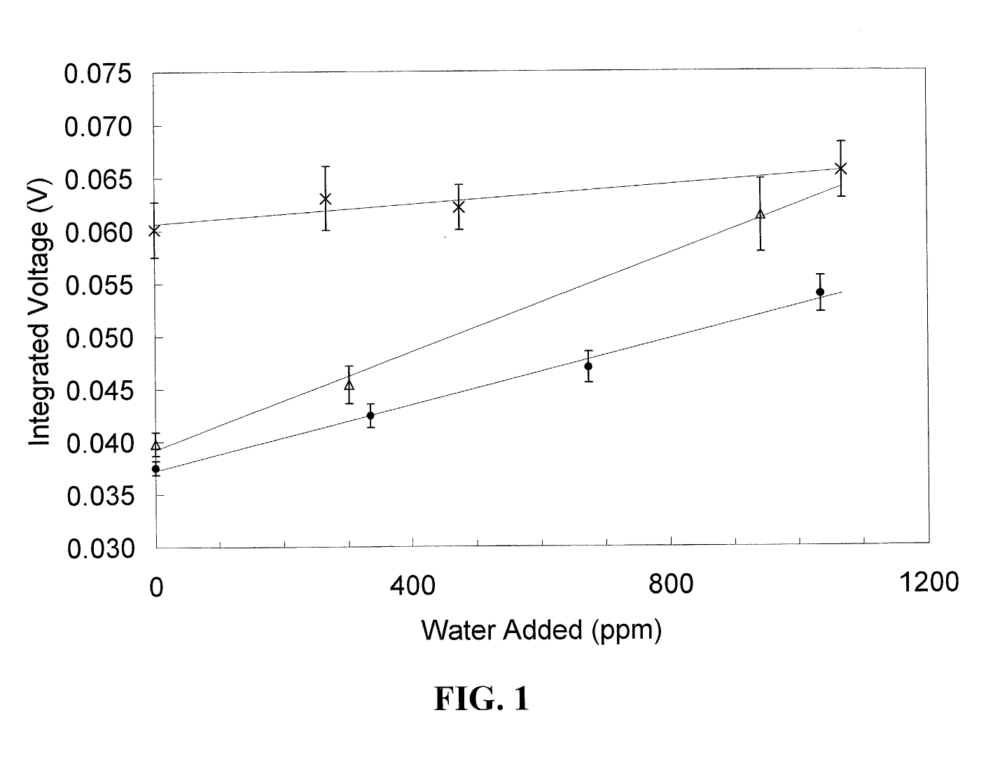

The absorption maximum of pure water (A=12,262 cm^{-1,}ε=221 M⁻¹cm⁻¹) is at 2.935 μm (3407 cm⁻¹) and the wavelength region where 95% of the maximum absorbance occurs extends from about 2.90-2.97 μm (Hale, G. H. and M. R. Querry, Optical constants of water in the 200 nm to 200 μm wavelength region. Appl. Opt., 1973. 12: p. 555-563; Wieliczka, D. M., S. Weng, and M. R. Querry, Wedge shaped cell for highly abosorbent liquids. infrared optical constants of water. Appl. Opt., 1989.28: p. 1714-1719). Although the value of the absorption coefficient for water in a petroleum-based oil matrix was unknown, it is not likely to change significantly, therefore, this wavelength region was selected as the most likely to yield the low detection limits required. Standard curves for clean hydraulic, transmission, and engine oils with water using 2.93 μm as the excitational wavelength are plotted in FIG. 1. Detection limits for water were calculated to be 60 ppm in hydraulic oil, 45 ppm in transmission oil and 515 ppm in engine oil. The detection limits for the hydraulic and transmission oils are 5-10× lower than those obtainable with FTIR.

According to Toms (Toms, L. A., Machinery Oil Analysis: Methods, Automation & Benefits. 2nd ed. 1998, p. 143, Virginia Beach: Coastal Skills Training) the absorption maximum for water in synthetic oils splits into two bands at 2.75 and 2.82 μm (3640 and 3550 cm⁻¹). Light absorption by the synthetic oil at 2.93 μm was due mainly to antioxidant additives, although some absorption due to water was present and yielded the observed PA response. The location of the water absorption bands by differential FTIR analysis of the engine oil as received and after addition of 1000 ppm water was confirmed (data not shown). Consequently, at the excitation wavelength used, one would not be expected to be able to detect water in this engine oil by PAS with the same sensitivity achieved for the hydraulic and transmission oils.

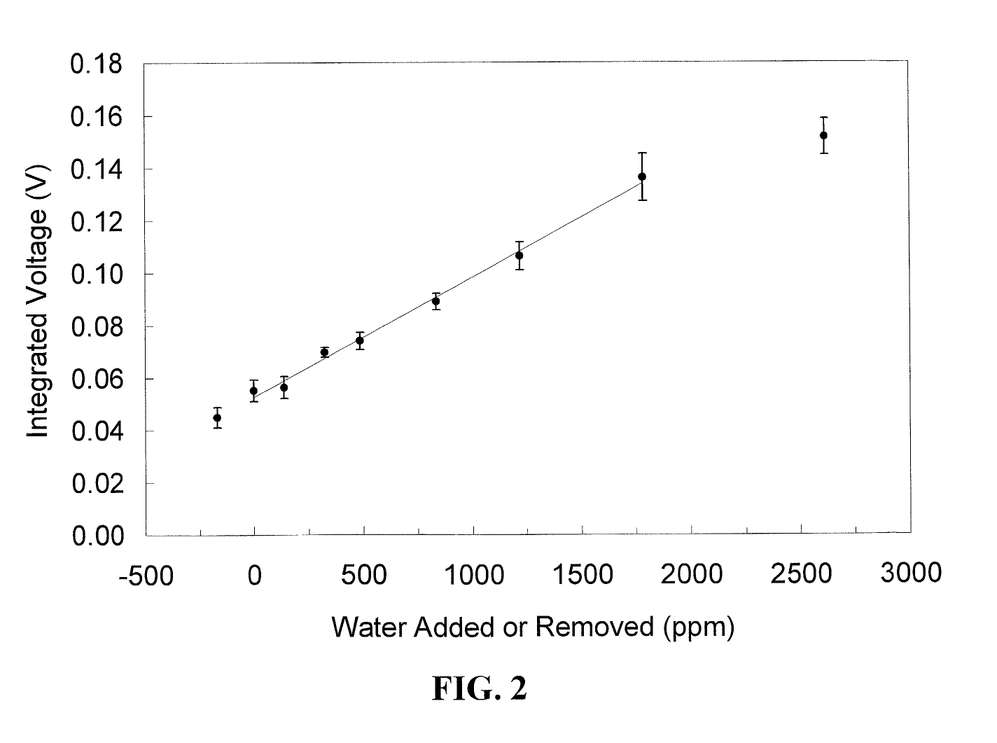

In a second experiment, the transmission oil and a wider range of water contents was studied, including a sample of the oil treated with a molecular sieve to remove water initially present. The results showed a linear response to about 1800 ppm added water (FIG. 2). Above this value incomplete miscibility occurred (emulsification was not attempted) and so a lower signal was obtained than expected. To determine the amount of water present in the original oil, the molecular-sieve material was added to this oil to remove all water and the PA signal was measured. The signal obtained corresponded to an “added water” concentration of −170 ppm, suggesting that the original concentration of water in the oil was 170 ppm.

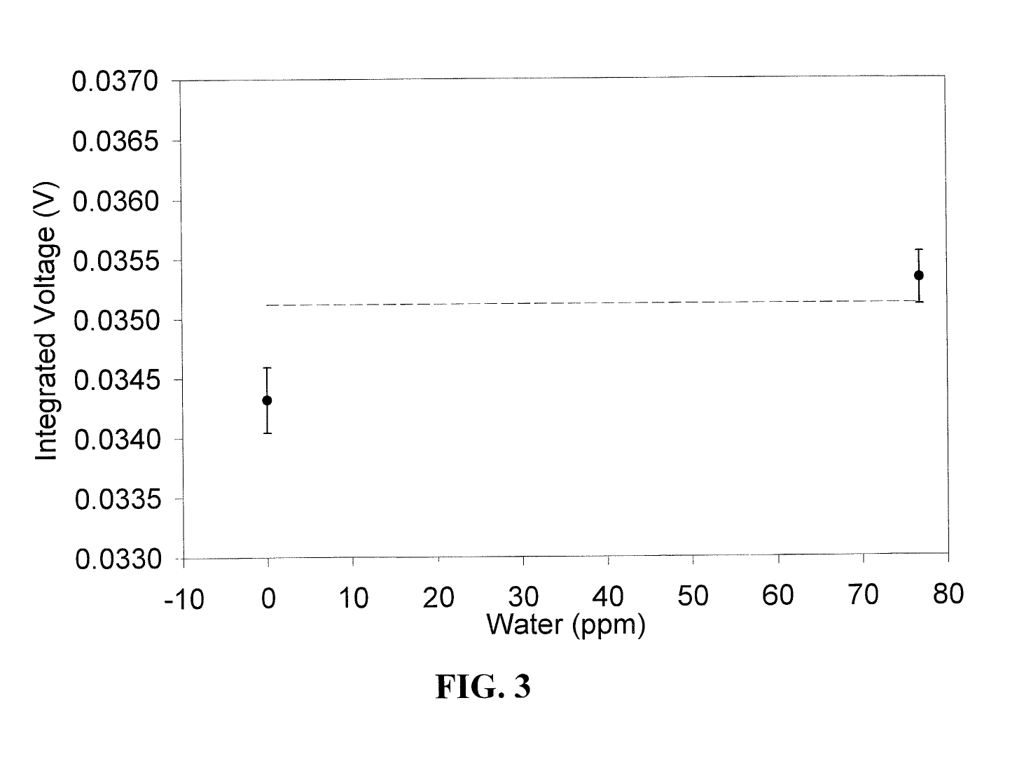

In a third experiment, two samples of the NIST reference oil, one as received and one after treatment with the molecular sieve for 48 hours to remove water, were analyzed. The results of these analyses (FIG. 3) clearly show the ability of PAS to distinguish between 77 and 0 ppm water in this sample (the error bars in the figure are one standard deviation of the data). The calculated detection limit for this sample was 62 ppm water. This is shown as a dashed line in FIG. 3.

Although the description above contains many specificities, these should not be construed as limiting the scope of the invention but as merely providing illustrations of some of the presently-preferred embodiments of this invention. For example, light sources and sample cells different from those specifically illustrated herein may be used. Also, different detection and data analysis and collection devices may be used from those specifically illustrated herein. Thus, the scope of the invention should be determined by the appended claims and their legal equivalents, rather than by the examples given. All references cited herein are hereby incorporated by reference to the extent not inconsistent with the disclosure herewith.

We claim:

1. A method of determining the concentration of a substance of interest in a nonwater sample comprising:
exciting the sample with a wavelength of light that is absorbed by the substance of interest;
generating an acoustic wave within the sample;
detecting the acoustic wave; and
determining the amount of the substance of interest present in the sample.

2. The method of claim 1, wherein the substance of interest is present at a concentration less than 1% in the sample.

3. The method of claim 1, wherein the nonwater sample consists essentially of oil.

4. The method of claim 3, wherein the sample is synthetic oil.

5. The method of claim 1, wherein the nonwater sample consists essentially of hydrocarbon-based fuel.

6. The method of claim 1, wherein the nonwater sample is not a biological fluid.

7. The method of claim 1, wherein the substance of interest is water.

8. The method of claim 7, wherein the concentration of water in the sample is less than about 250 ppm.

9. The method of claim 7, wherein the concentration of water in the sample is less than about 100 ppm.

10. The method of claim 7, wherein the concentration of water in the sample is less than about 1%.

11. The method of claim 7, wherein the wavelength of light is between about 2.6 μm and 3.0 μm.

12. The method of claim 1, wherein the light is pulsed or modulated.

13. The method of claim 1, wherein the nonwater sample comprises oil.

14. The method of claim 1, wherein the acoustic wave is detected by a transducer in acoustic communication with the sample.

15. A method of determining the concentration of water in an oil sample which contains less than 1% water comprising:
exciting the sample with light having a wavelength water absorbs;
generating an acoustic wave within the sample;
detecting the acoustic wave with a transducer in acoustic communication with the sample; and
determining the amount of water present in the sample by processing the signal detected by the transducer.

16. The method of claim 15, wherein the oil sample is synthetic oil.

17. The method of claim 15, wherein the light is pulsed or modulated.

18. A method of determining the concentration of water in a nonwater sample, comprising:
exciting the sample with light having a wavelength which is less than 1 mm;
generating an acoustic wave within the sample;
detecting the acoustic wave with a transducer in acoustic communication with the sample;
and determining the amount of water present in the sample by processing the signal detected by the transducer.

19. The method of claim 18, wherein the nonwater sample comprises oil.

20. The method of claim 18, wherein the nonwater sample consists essentially of oil.

21. The method of claim 20, wherein the sample is synthetic oil.

22. The method of claim 18, wherein the nonwater sample consists essentially of hydrocarbon-based fuel.

23. The method of claim 18, wherein the light is pulsed or modulated.

24. An apparatus for determining the concentration of a substance of interest in a nonwater sample comprising:
an excitation source which provides light having a wavelength that is absorbed by water;
a sample in light contact with the excitation source; and
a detector in acoustic communication with the sample.

25. The apparatus of claim 24, wherein the excitation source is a pulsed or modulated source.

26. The apparatus of claim 24, wherein the sample comprises oil.

27. The apparatus of claim 26, wherein said oil is synthetic.

28. The apparatus of claim 24, wherein the sample comprises hydrocarbon-based fuel.

29. The apparatus of claim 24, wherein said detector is a transducer.

30. The apparatus of claim 24, wherein said substance of interest is water.

31. The apparatus of claim 24, wherein said apparatus is located in a flow stream.

32. An apparatus for determining the concentration of water in an oil sample comprising:
an excitation source which provides pulsed or modulated light having a wavelength water absorbs;
a prism cell in light contact with the excitation source; and
a transducer in acoustic communication with the sample.
